(19) United States
(12) Patent Application Publication
(10) Pub. No.: US 2007/0019130 A1
(43) Pub. Date: Jan. 25, 2007

(54) LIQUID CRYSTAL DISPLAY

(75) Inventor: Yen-Hsun Kuo, Hsinchu (TW)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: INDUSTRIAL TECHNOLOGY RESEARCH INSTITUTE, Hsinchu (TW)

(21) Appl. No.: 11/458,761

(22) Filed: Jul. 20, 2006

(30) Foreign Application Priority Data
Jul. 22, 2005 (TW) 094124985

(51) Int. Cl. G02F 1/1335

(52) U.S. Cl. 349/65

(57) ABSTRACT

A liquid crystal display (LCD) including a liquid crystal panel and a dot-matrix backlight source is provided. The liquid crystal panel includes a display surface and a surface for combining lighting-emitting surface. In addition, the dot-matrix backlight source has a light-emitting surface. When the lighting-emitting surface is combined to the surface for combining lighting-emitting surface, the light emitted by the dot-matrix backlight source is used as backlight for providing light source for the liquid crystal panel of the LCD.

### CROSS-REFERENCE TO RELATED APPLICATIONS

This non-provisional application claims priority under 35 U.S.C. §119(a) on patent application Ser. No(s). 094124985 filed in Taiwan, R.O.C. on Jul. 22, 2005, the entire contents of which are hereby incorporated by reference.

### BACKGROUND OF THE INVENTION

1. Field of Invention

The present invention relates to a liquid crystal display (LCD), and more particularly to an LCD using a dot-matrix backlight source as a backlight source.

2. Related Art

With the rapid progress of the apparatus and method for manufacturing the liquid crystal display (LCD), LCD has been gradually expanding its application field, and has transferred from desktop display to the field of household television. Currently, the government in each country has actively declared that the digital information era is coming, and thus, the LCD is considered as the product for replacing the Cathode-Ray Tube (CRT) in the future. Accordingly, as the improvement of the manufacturing technique and the expansion of the production line for machines and equipments by the panel manufactures in Japan, South Korea, and ROC, the production yield of LCD all over the world is increasingly enhanced year by year. The size of the panel for the LCD has gradually developed from 30 inch to 40 inch. It seems that a cyclone of flat panel display is going to sweep the world. Most countries including Japan, USA, and Taiwan have also promoted the digital television strategy, and it is predicted that, the current analog system will be gradually knock out from the year of 2006 to 2008, thus indirectly accelerating the popularization of the LCD. It is believed that in the near future, the LCD will become an indispensable means for providing multimedia information in living room or even in bedroom of each family.

However, the LCD also has poor congenital characteristics, which are sufficient for influencing its application field. In particular, when being applied to display the dynamic image of information, the LCD has many limitations in comparison with the cathode-ray tube display. Thus, it has becomes an important technical challenge in the LCD industry to eliminate the poor image defects. Moreover, referring to FIG. 1, it is a schematic view of a conventional LCD PI using a Cold Cathode Fluorescent Lamp (CCFL) P11 as a backlight source. A backlight module P10 of the CCFL is used together with a liquid crystal panel P20, however, the color gamut range of the displayed color only reaches 60% to 65% of that of the National Television System Committee (NTSC), which is less than the average color gamut of the cathode-ray tube display, that is 71%, and the narrower color gamut range causes poor saturation of the color of the LCD P1. Next, the tube itself has defects in its own characteristic. The life time of the CCFL P11 is limited, thus after being used for a certain time period, the tube must be replaced by a new one to maintain the intensity of the display. The backlight module using the CCFL comprises various components such as lamp source (CCFL P11), reflecting plate P12, light guide plate P13, diffuser plate P14, and prism sheet P15. Although the CCFL has desirable light emitting efficiency (80 lm/W), the photovoltaic conversion efficiency has greatly lost after the light has passed through the backlight module with multiple layers of optical components, thereby resulting in poor energy utilization efficiency of the whole backlight module.

Therefore, the conventional LCD using CCFL has the defect that the light source cannot meet the demanding, thus, how to redesign an LCD using a backlight source having desirable color saturation has become an object for the operators during the researching and development.

### SUMMARY OF THE INVENTION

In view of the problems of the prior art, the present invention provides a liquid crystal display (LCD), for overcoming the defects of the conventional LCD backlight module such as poor color saturation, thick volume, and high manufacturing cost, and also, for overcoming the defect of the conventional LCD backlight module that a plurality of optical devices are required to guide the lights such that the light source utilization efficiency is reduced.

In order to achieve the above object, the present invention provides a liquid crystal display (LCD), which comprises a liquid crystal panel and a dot-matrix backlight source. The liquid crystal panel has a display surface and a surface for combining light-emitting surface, and the liquid crystal panel further comprises a plurality of pixel units. Moreover, the dot-matrix backlight source is a dot-matrix backlight module having a light-emitting surface, and it is formed by a plurality of light-emitting units. The dot-matrix backlight source combines its light-emitting surface to the surface for combining light-emitting surface of the liquid crystal panel by way of providing backlight, so as to provide the backlight source required by the liquid crystal panel of the LCD.

In addition, the present invention further provides a dot-matrix backlight source used as the LCD backlight source, wherein the dot-matrix backlight source has a light-emitting surface, and it is formed by a plurality of light-emitting units. The dot-matrix backlight source combines its light-emitting surface to the surface for combining light-emitting surface of the liquid crystal panel of the LCD by way of providing backlight.

The present invention uses a dot-matrix backlight source functioning as the backlight source of the LCD in a dot-to-dot driving mode, therefore, each point light source can be operated independently and modulated separately.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only for, which thus is not limitative of the present invention, and wherein:

FIG. 1 is a schematic view of a conventional LCD using a cold-cathode tube as the backlight source.

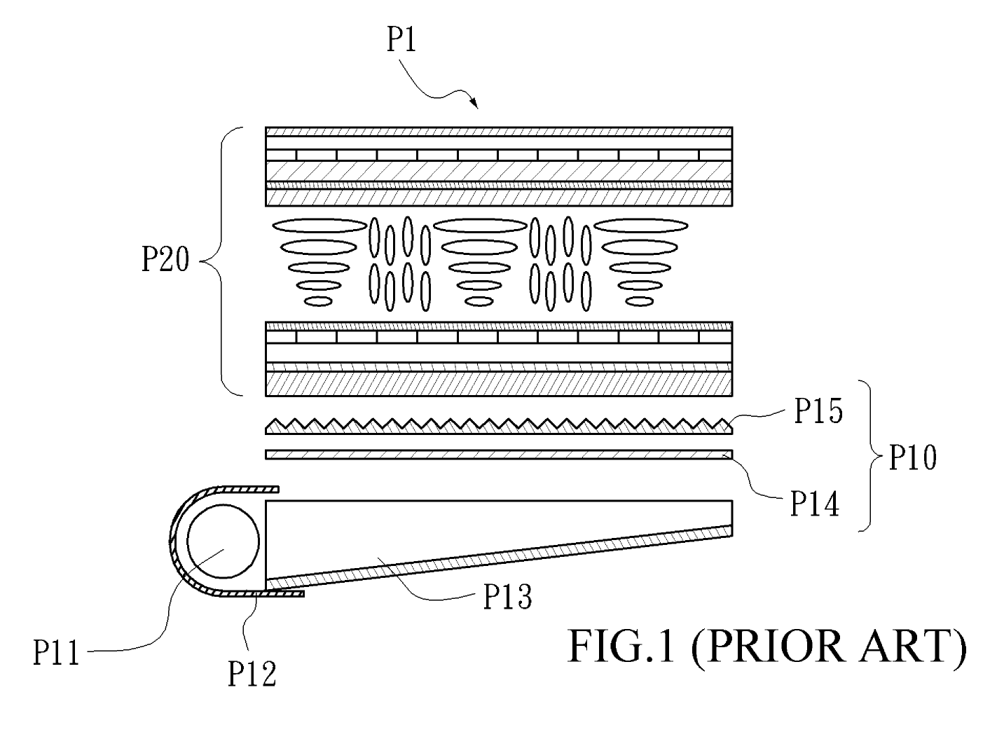

FIG. 2A is a diagram of an embodiment of an LCD according to the present invention.

FIG. 2B is a diagram of an embodiment of the LCD in FIG. 2A further disposed with a spacer.

FIG. 3 is a diagram of an embodiment of an LCD using a plasma display panel as the dot-matrix electro-luminescent display according to the present invention.

FIG. 4 is a diagram of an embodiment of an LCD using a field-emission display as the dot-matrix electro-luminescent display according to the present invention.

### DETAILED DESCRIPTION OF THE INVENTION

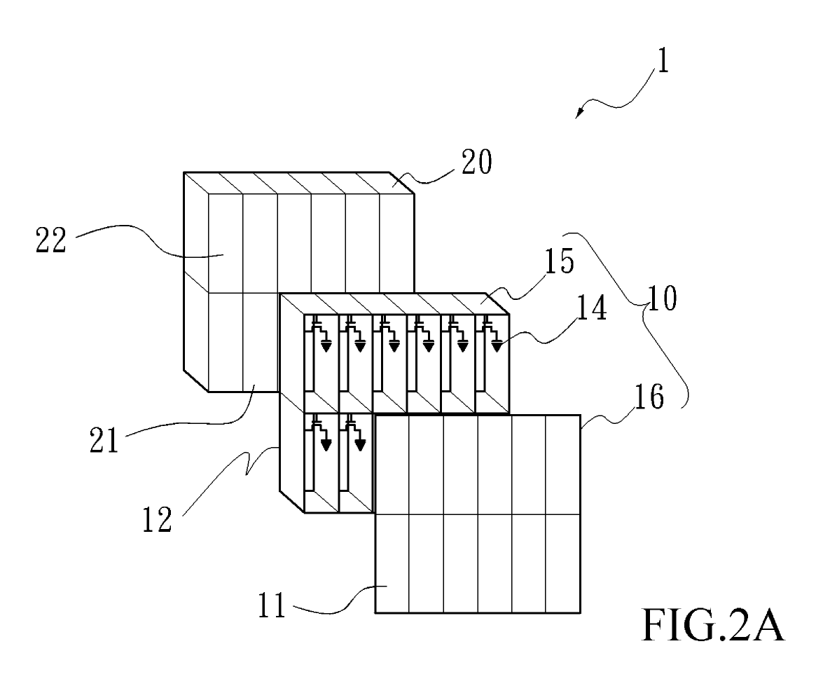

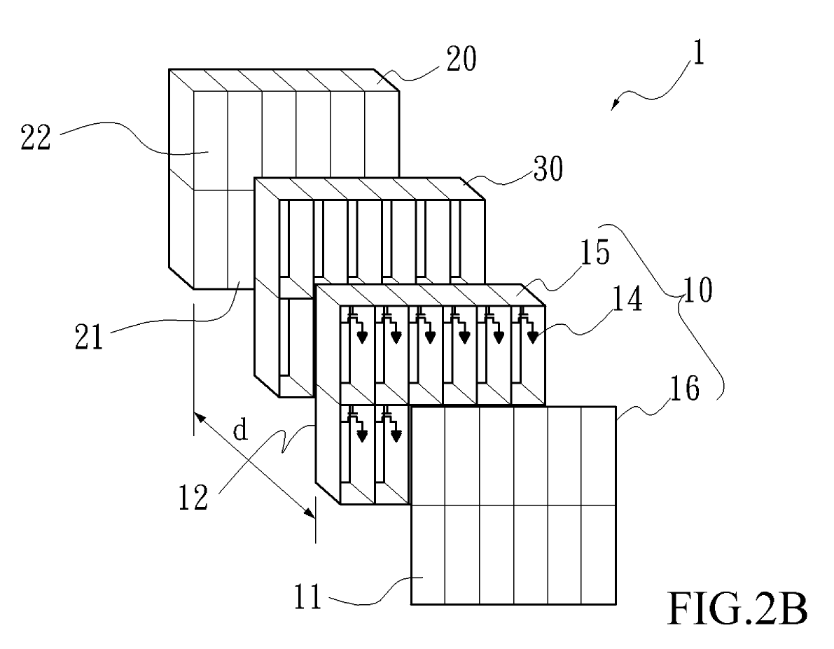

Referring to FIG. 2A, it is a diagram of an embodiment of an LCD according to the present invention. The LCD 1 comprises a liquid crystal panel 10 and a dot-matrix backlight source 20. The liquid crystal panel 10 has a display surface 11 and a surface for combining light-emitting surface 12, and the liquid crystal panel 10 further comprises a plurality of pixel units 14. Furthermore, the dot-matrix backlight source 20 of the LCD 1 has a light-emitting surface 21, and the dot-matrix backlight source 20 is formed by a plurality of light emitting units 22. During the fabrication process, the light-emitting surface 21 of the dot-matrix backlight source 20 is combined to the surface for combining light-emitting surface 12 of the liquid crystal panel 10, such that the light emitted from the dot-matrix backlight source 20 can be used to provide the backlight source required by the liquid crystal panel 10 of the LCD 1 in a manner of providing backlight. The liquid crystal panel 10 mainly comprises a glass substrate 15 and a filter 16, and certainly comprises other optical components, which will not be described herein, since they are mentioned in the conventional art.

As shown in FIG. 2B, it is a diagram of an embodiment of the LCD depicted in FIG. 2A, which is further disposed with a spacer. In order to avoid the Moire pattern occurring to the light beams generated from dot-matrix backlight source 20 caused by an excessive small interval between the liquid crystal panel 10 and the dot-matrix backlight source 20 when both of them are directly combined to each other and thereby influencing the optical quality of the display, the LCD 1 of this embodiment further comprises a spacer 30. The spacer 30 is disposed between the liquid crystal panel 10 and the dot-matrix backlight source 20, for enlarging the interval between the liquid crystal panel 10 and the dot-matrix backlight source 20, so as to eliminate the Moire pattern and enhance the optical quality of the display.

The spacer 30 in this embodiment is a black-stripe layer, which is formed at the periphery of each light emitting unit 22 for the dot-matrix backlight source 20. The spacer 30 has a thickness d, preferably between 1 nm and 1 mm. The LCD 1 further added with the spacer 30 comprises a liquid crystal panel 10, a spacer 30, and a dot-matrix backlight source 20. After the spacer 30 has been added, the liquid crystal panel 10 and dot-matrix backlight source 20 are not changed, thus the liquid crystal panel 10 still has a display surface 11 and a surface for combining light-emitting surface 12. Further, the dot-matrix backlight source 20 also has a light-emitting surface 21, and it is formed by a plurality of light emitting units 22. The light-emitting surface 21 of the dot-matrix backlight source 20 is combined to a surface of the spacer 30, and the other surface of the spacer 30 is combined to the surface for combining light-emitting surface 12 of the liquid crystal panel 10. The light emitted from the dot-matrix backlight source 20 passes through the spacer 30 to provide the light source required by the liquid crystal panel 10 of the LCD 1 in a manner of providing backlight.

The dot-matrix backlight source 20 is formed by a plurality of light emitting units 22, and the liquid crystal panel 10 has a plurality of pixel units 14. At this point, the area of each light emitting unit 22 of the dot-matrix backlight source 20 is n times of that of each pixel unit 14 of the liquid crystal panel 10, wherein n is an integer. Also, the corresponding relationship between the light emitting units 22 of the dot-matrix backlight source 20 and the pixel units 14 of the liquid crystal panel 1 is that one light emitting unit 22 corresponds to 1-n pixel units 14, that is, one light emitting unit 22 can provide the backlight source required by 1-n pixel units 14.

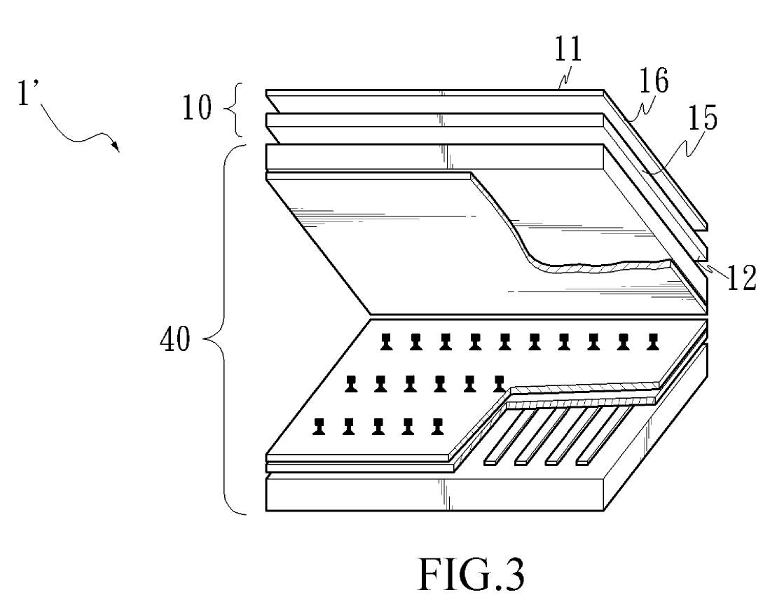

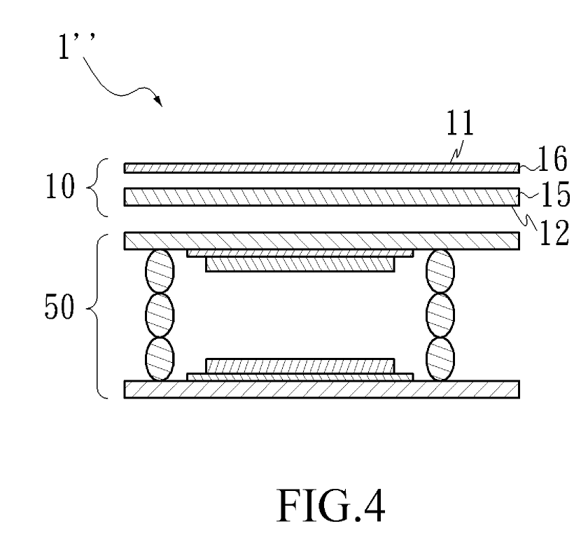

In order to achieve desirable backlight source effect, the dot-matrix backlight source 20 used in the LCD 1 of this embodiment is a dot-matrix electro-luminescent display for emitting white lights. The dot-matrix electro-luminescent display can be an organic light emitting display, or an inorganic light emitting display. Further, referring to FIG. 3, it is a diagram of an embodiment of an LCD using a plasma display panel as the dot-matrix electro-luminescent display according to the present invention. In this embodiment, the dot-matrix electro-luminescent display can be a plasma display panel. The liquid crystal panel 10 is disposed on the plasma display panel 40, and the light source required by the liquid crystal panel 10 of the LCD 1′ is provided by the lights emitted from the plasma display panel 40 in the manner of providing backlight. Further, referring to FIG. 4, it is a diagram of an embodiment of an LCD using a field-emission display as the dot-matrix electro-luminescent display according to the present invention. In this embodiment, the dot-matrix electro-luminescent display also can be a field-emission display 50. The liquid crystal panel 10 is disposed on the field-emission display 50 for providing the light source required by the liquid crystal panel 10 of the LCD 1″. Alternatively, the dot-matrix electro-luminescent display is a carbon nanotube field emission display (CNT-FED).

Through implementing the present invention, at least the following efficacies can be achieved.

1. A dot-matrix backlight source is used as the backlight source of the LCD in a dot-to-dot driving mode, therefore, compared with the backlight module of the conventional LCD, it has the advantage that each point light source can be operated independently and can be modulated separately.

2. The dot-matrix backlight source used as the backlight source of the LCD is made of self-luminous material with lower power consumption, therefore, compared with the conventional LCD, no additional optical conduction and divergence components is required, thereby avoiding the attenuation of light utilization efficiency, so as to save the energy.

3. The dot-matrix backlight source used as the backlight of the LCD has the feature of being light and thin in volume, therefore, compared with the backlight module of the conventional LCD, it significantly reduces the volume and saves the cost.

4. An LCD of the present invention using the dot-matrix backlight source as the backlight source controls each pixel and partially modulates the light for the area of the picture, therefore, the visual quality of the display can be improved by modulating the point backlight to change the dynamic contrast and dynamic intensity in dynamic images.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A liquid crystal display (LCD), comprising:
a liquid crystal panel, having a display surface and a surface for combining light-emitting surface, and having a plurality of pixel units; and
a dot-matrix backlight source, having a light-emitting surface, and formed by a plurality of light-emitting units, wherein the light-emitting surface is combined to the surface for combining light-emitting surface of the liquid crystal panel in a manner of providing backlight.

2. The LCD as claimed in claim 1, wherein the dot-matrix backlight source is a dot-matrix electro-luminescent display for emitting white lights.

3. The LCD as claimed in claim 1, further comprises a spacer disposed between the liquid crystal panel and the dot-matrix backlight source.

4. The LCD as claimed in claim 3, wherein the thickness d of the spacer is within the range of 1 nm to 1 mm.

5. The LCD as claimed in claim 3, wherein the spacer is a black-stripe layer.

6. The LCD as claimed in claim 1, wherein the area of each light-emitting unit is n times of that of each pixel unit, and n is an integer.

7. The LCD as claimed in claim 1, wherein each light-emitting unit corresponds to 1-n pixel units.

8. The LCD as claimed in claim 2, wherein the dot-matrix electro-luminescent display is an organic light emitting display or an inorganic light emitting display.

9. The LCD as claimed in claim 2, wherein the dot-matrix electro-luminescent display is a field-emission display or a carbon nanotube field emission display (CNT-FED).

10. The LCD as claimed in claim 2, wherein the dot-matrix electro-luminescent display is a plasma display panel.

11. A dot-matrix backlight source used as a backlight source of a liquid crystal display (LCD), having a light-emitting surface formed by a plurality of light emitting units, wherein the light-emitting surface is combined to the surface for combining light-emitting surface of a liquid crystal panel of the LCD in a manner of providing backlight.

12. The dot-matrix backlight source as claimed in claim 11, wherein the dot-matrix display is a dot-matrix electro-luminescent display for emitting white lights.

13. The dot-matrix backlight source as claimed in claim 11, wherein the dot-matrix electro-luminescent display is an organic light emitting display or an inorganic light emitting display.

14. The dot-matrix backlight source as claimed in claim 11, wherein the dot-matrix electro-luminescent display is a field-emission display or a carbon nanotube field emission display (CNT-FED).

15. The dot-matrix backlight source as claimed in claim 11, wherein the dot-matrix electro-luminescent display is a plasma display panel.
